(19) United States
(12) Patent Application Publication
(10) Pub. No.: US 2025/0287935 A1
(43) Pub. Date: Sep. 18, 2025

(54) COMPUTER-IMPLEMENTED METHOD FOR CONTROLLING PESTS

(71) Applicant: BASF SE, Ludwigshafen am Rhein (DE)

(72) Inventors: Pilar PUENTE, Limburgerhof (DE); Mark KEARNS, Durham, NC (US)

(21) Appl. No.: 18/860,344

(22) PCT Filed: Apr. 21, 2023
(86) PCT No.: PCT/EP2023/060392

§ 371 Date: Oct. 25, 2024

(30) Foreign Application Priority Data
Apr. 25, 2022 (EP) 22169846.7

(51) Int. Cl. A01M 17/00; A01G 13/10; A01M 1/20; G06Q 10/0631; G06Q 50/02

(52) U.S. Cl. CPC A01M 17/008; A01G 13/105; A01M 1/20; G06Q 10/06315; G06Q 50/02

(57) ABSTRACT

In order to effectively apply semiochemical treatment products, a computer-implemented method is provided for generating an application scheme for a semiochemical treatment for controlling a harmful organism on an agricultural field using a mobile treatment device comprising at least one dispenser, the method comprising:
a) providing information about an expected presence of the harmful organism for an upcoming period;
b) providing, based on the expected presence of the harmful organism, a planned application timing of applying the semiochemical treatment for treating the harmful organism on the agricultural field;
c) providing product data relating to a semiochemical product capable of targeting the harmful organism;
d) providing, at least one of field data or environmental data at the planned application timing, wherein the field data is indicative of a field condition at the planned application timing and/or the environmental data is indicative of an environmental condition at the planned application timing;
e) determining, based on the product data and the at least one of field data or the environmental data at the planned application timing, a minimum concentration of the semiochemical product for affecting a behaviour of the harmful organism;
f) determining, based on the minimum concentration of the semiochemical product, a dose rate of the selected semiochemical product to be spread by the at least one dispenser into an atmospheric vapour forming a cloud which envelops crops on the agricultural field; and
g) generating the application scheme based on the determined dose rate.

### FIELD OF THE INVENTION

The present invention relates to pest control, and in particular relates to a computer-implemented method and an apparatus for generating an application scheme for a semiochemical treatment for controlling a harmful organism on an agricultural field using a mobile treatment device comprising at least one dispenser, to a mobile treatment system, to a computer program element, to a computer readable medium, and to use of application scheme in a mobile treatment device.

### BACKGROUND OF THE INVENTION

Semiochemicals have been used as plant protection products. For example, pheromones are chemicals produced by an insect to communicate in some way with others of the same species. Currently, pheromones unique to a particular insect are being investigated for their potential in trapping and/or reducing the reproduction of the insect, for example, so as to reduce the size of the population to acceptable levels in vulnerable crops. Mating disruption involves the use of sex pheromones to prevent male insects finding females and mating. A pheromone chemical compound's mode of action is specific, so that it is safe to humans and other beneficial organisms. However, pest control using semiochemicals may be more complex and may cost more than simply applying an insecticide.

### SUMMARY OF THE INVENTION

There may be a need to effectively apply semiochemical treatment products.

The object of the present invention is solved by the subject-matter of the appended independent claims, wherein further embodiments are incorporated in the dependent claims.

According to a first aspect of the invention, there is provided a computer-implemented method for generating an application scheme for a semiochemical treatment for controlling a harmful organism on an agricultural field using a mobile treatment device comprising at least one dispenser, the method comprising:
a) providing information about an expected presence of the harmful organism for an upcoming period;
b) providing, based on the expected presence of the harmful organism, a planned application timing of applying the semiochemical treatment for treating the harmful organism on the agricultural field;
c) providing product data relating to a semiochemical product capable of targeting the harmful organism;
d) providing at least one of field data or environmental data at the planned application timing, wherein the field data is indicative of a field condition at the planned application timing and/or the environmental data is indicative of an environmental condition at the planned application timing;
e) determining, based on the product data and the at least one of field data or the environmental at the planned application timing, a minimum concentration of the semiochemical product for affecting a behaviour of the harmful organism;
f) determining, based on the minimum concentration of the semiochemical product, a dose rate of the selected semiochemical product to be spread by the at least one dispenser into an atmospheric vapour forming a cloud which envelops crops on the agricultural field; and
g) generating the application scheme based on the determined dose rate.

During a season, different situations may occur that require an adjustment of the dose rate to reach optimal efficacy of the harmful organism management. Based on digitally available data on the harmful organisms, such as the expected presence of the harmful organism and the product data of the semiochemical(s) to be used, a minimum concentration of the semiochemical(s) may be determined and the dose rate may be specifically adjusted to the kind of harmful organism, as well as to the harmful organism population according to the method as described herein. Thereby, an improved efficacy can be achieved for individual harmful organism to be controlled.

The minimum concertation may be increased to account for the loss of the semiochemical product in the agricultural field. The minimum concentration of the semiochemical product is adjusted to account for a loss or dissipation of the selected semiochemical product caused by the field condition and/or the environmental condition. Exemplary environmental conditions may include, but are not limited to, wind effects, temperature and humidity (which may cause evaporation in the sky), and absorption by soil. Exemplary field conditions may include, but are not limited to field topography, particular and specific field conditions (presence of roads, flow of water, etc.), and field edges. The losses may be estimated based on historic collected data. Based on the estimated losses, the minimum concentration may be adjusted to account for the losses.

This will be explained in detail hereinafter and in particular with respect to the example shown in FIG. 3.

According to an embodiment of the present invention, crop data is provided relating to a crop grown or to be grown and an expected crop height and/or an expected crop density at the at least one planed application timing. Alternatively or additionally, field data is provided indicative of a field topographic condition. Positioning of the at least one dispenser for spreading the selected semiochemical product is determined based at least on the crop data and/or the field topographic condition.

In general, the dispenser(s) of the mobile treatment device should be displaced to release the semiochemical product(s) as uniformly as possible with the exception of areas featuring particular topographic conditions or characterized by the presence of tall crops.

In order to enable the generation of a homogeneous cloud of the semiochemical product(s) for the areas characterized by the presence of tall crops, it may be beneficial to have height-adjustable dispenser(s), which may be adjusted to release the semiochemical product at a desired vertical position, e.g., positioning the dispenser(s) in the upper third of the crop.

In order to enable the generation of a homogeneous cloud of the semiochemical product(s) for the areas featuring particular topographic conditions, the dispenser(s) may need to be displaced irregularly with more release of semiochemical product in the upper part of the slope and fewer release of the semiochemical product in the lower part of the valley, thus leaving the overall dosage unchanged.

According to an embodiment of the present invention, the method further comprises the steps of providing real-time tracking data indicative of a real-time change of the cloud of the selected semiochemical product formed in the atmosphere, and adjusting, based on the real-time tracking data, the planned application timing of applying the selected semiochemical product.

It may be preferred that the semiochemical product remains nearly constant throughout the period of the treatment as long as external wind speeds and air temperatures remain the same. Therefore, in order to ensure the constant presence of the minimum concentration of the semiochemical product throughout the period of the treatment, real-time tracking data indicative of a real-time change of the cloud of the selected semiochemical product formed in the atmosphere may be provided. The real-time tracking data is acquired by a physical sensor or estimated via a cloud simulation. Based on the real-time tracking data, the planned application timing of applying the semiochemical product may be adjusted. For example, if it is determined that the loss of the semiochemical product (e.g., due to increased wind speeds and air temperature) is higher than the estimation, the next application timing may be adjusted.

According to an embodiment of the present invention, the real-time tracking data is acquired by a physical sensor or estimated via a cloud simulation.

According to an embodiment of the present invention, the method further comprises the step of generating a control file comprising control parameters to control the mobile treatment device for a semiochemical treatment for treating the harmful organism in accordance with the application scheme.

The control file may be any binary file, data, signal, identifier, code, image, or any other machine-readable or machine-detectable element useful for controlling the mobile treatment device.

According to an embodiment of the present invention, the method further comprises the step of providing the generated application scheme via a user interface to guide a user to control the mobile treatment device for a semiochemical treatment for treating the harmful organism.

In some examples, the generated application scheme may be provided as a recommendation by means of a user interface. The recommendation may comprise a filling guidance including the required semiochemical products and their ratios to be filled into one or more tanks of a dispenser or any other mixing unit.

According to an embodiment of the present invention, the semiochemical product comprises one or more of a pheromone product, an allomone product, a kairomone product, an attractant product, and a repellent product.

According to a second aspect of the present invention, there is provided an apparatus for generating an application scheme for a semiochemical treatment for controlling a harmful organism on an agricultural field using a mobile treatment device comprising at least one dispenser, the apparatus comprising one or more processing units to generate the application scheme, wherein the one or more processing units receive instructions, which when executed on the one or more processing units, perform the method steps of the first aspect and any associated example.

This will be explained in detail hereinafter and in particular with respect to the example shown in FIG. 1.

According to a third aspect of the present invention, there is provided a harmful organism management system. The mobile treatment system comprises an apparatus configured to generate an application scheme for a semiochemical treatment for controlling a harmful organism on an agricultural field according to the second aspect and any associated example, and a mobile treatment device comprising at least one dispenser configured to implement the application scheme.

This will be explained in detail hereinafter and in particular with respect to the example shown in FIG. 2.

According to an embodiment of the present invention, the mobile treatment device is configured to implement the application scheme when a presence of the harmful organism exceeds the thresholds specifically established for the control of the harmful organism.

According to another aspect of the present invention, there is provided a computer program element comprising instructions to cause the apparatus of the second aspect or the system of the third aspect to execute the steps of method of the first aspect and any associated example.

According to a further aspect of the present invention, there is provided a computer readable medium having stored the program element.

According to a still further aspect of the present invention, there is provided use of application scheme generated in a mobile treatment device.

### DEFINITIONS

As used herein, the term “agricultural field” may be any area in which organisms, particularly crop plants, are produced, grown, sown, and/or planned to be produced, grown or sown. The term “agricultural field” also includes horticultural fields, silvicultural fields and fields for the production and/or growth of aquatic organisms.

As used herein, the term “application map” may be understood to be a map indicating a two-dimensional spatial distribution of the amounts, or dose rates, or types, or forms of products which should be applied on different locations or zones within an agricultural field.

As used herein, the term “semiochemical” may refer to chemicals emitted by plants, animals, and other organisms, and synthetic analogues of such substances that evoke a behavioural or physiological response in individuals of the same or other species. Examples of semiochemicals may include, but not limited to, allelochemicals, pheromones, and straight-chained lepidopteran pheromones (SCLPs). Allelochemicals are produced by individuals of one species that modify the behaviours of individuals of a different species (i.e., an interspecific effect). Allelochemicals include allomones (emitting species benefits), kairomones (receptor species benefits), and synomones (both species benefits). Pheromones are produced by individuals of a species that modify the behaviours of other individuals of the same species (i.e., an intraspecific effect). SCLPs are a group of pheromones consisting of unbranched aliphatics having a chain of nine to eighteen carbons, containing up to three double bonds, ending in an alcohol, acetate, or aldehyde functional group. This structure definition encompasses the majority of known pheromones produced by insects in the order Lepidoptera, which includes butterflies and moths.

As used herein, the term “harmful organism” may be understood to be any organism, which has a negative impact to the growth or to the health of the agricultural crop plant.

As used herein, the term “dispenser” may refer to a device able to release semiochemicals at controlled release rates. The dispenser may be an active retrievable dispenser. The diffusion of the active ingredient occurs by turbulence-enhanced equilibrium of permeation from the device into the air where the active ingredient becomes diluted. The active substances are substances, including micro-organisms, which have general or specific action against harmful organisms or on plants, parts of plants or plant products.

As used herein, the term “crop” may refer to a plant such as a grain, fruit, or vegetable grown in large amounts. Preferred crops are: Allium cepa, Ananas comosus, Arachis hypogaea, Asparagus officinalis, Avena sativa, Beta vulgaris spec. altissima, Beta vulgaris spec. rapa, Brassica napus var. napus, Brassica napus var. napobrassica, Brassica rapa var. silvestris, Brassica oleracea, Brassica nigra, Camellia sinensis, Carthamus tinctorius, Carya illinoinensis, Citrus limon, Citrus sinensis, Coffea arabica (Coffea canephora, Coffea liberica), Cucumis sativus, Cynodon dactylon, Daucus carota, Elaeis guineensis, Fragaria vesca, Glycine max, Gossypium hirsutum, (Gossypium arboreum, Gossypium herbaceum, Gossypium vitifolium), Helianthus annuus, Hevea brasiliensis, Hordeum vulgare, Humulus lupulus, Ipomoea batatas, Juglans regia, Lens culinaris, Linum usitatissimum, Lycopersicon lycopersicum, Malus spec., Manihot esculenta, Medicago sativa, Musa spec., Nicotiana tabacum (N. rustica), Olea europaea, Oryza sativa, Phaseolus lunatus, Phaseolus vulgaris, Picea abies, Pinus spec., Pistacia vera, Pisum sativum, Prunus avium, Prunus persica, Pyrus communis, Prunus armeniaca, Prunus cerasus, Prunus dulcis and Prunus domestica, Ribes sylvestre, Ricinus communis, Saccharum officinarum, Secale cereale, Sinapis alba, Solanum tuberosum, Sorghum bicolor (S. vulgare), Theobroma cacao, Trifolium pratense, Triticum aestivum, Triticale, Triticum durum, Vicia faba, Vitis vinifera and Zea may. Most preferred crops are: Arachis hypogaea, Beta vulgaris spec. altissima, Brassica napus var. napus, Brassica oleracea, Citrus limon, Citrus sinensis, Coffea arabica (Coffea canephora, Coffea liberica), Cynodon dactylon, Glycine max, Gossypium hirsutum, (Gossypium arboreum, Gossypium herbaceum, Gossypium vitifolium), Helianthus annuus, Hordeum vulgare, Juglans regia, Lens culinaris, Linum usitatissimum, Lycopersicon lycopersicum, Malus spec., Medicago sativa, Nicotiana tabacum (N. rustica), Olea europaea, Oryza sativa, Phaseolus lunatus, Phaseolus vulgaris, Pistacia vera, Pisum sativum, Prunus dulcis, Saccharum officinarum, Secale cereale, Solanum tuberosum, Sorghum bicolor (S. vulgare), Triticale, Triticum aestivum, Triticum durum, Vicia faba, Vitis vinifera and Zea mays. Especially preferred crops are crops of cereals, corn, soybeans, rice, oilseed rape, cotton, potatoes, peanuts or permanent crops.

These and other aspects of the present invention will become apparent from and be elucidated with reference to the embodiments described hereinafter.

### BRIEF DESCRIPTION OF DRAWINGS

Exemplary embodiments of the invention will be described in the following with reference to the following drawings.

FIG. 1 illustrates a block diagram of an exemplary apparatus for generating an application scheme for a semiochemical treatment for controlling a harmful organism on an agricultural field using a mobile treatment device comprising at least one dispenser.

FIG. 2 illustrates an exemplary harmful organism management system for controlling a harmful organism on an agricultural field.

FIG. 3 shows a flow chart of a computer-implemented method for generating an application scheme for a semiochemical treatment for controlling a harmful organism on an agricultural field using a mobile treatment device comprising at least one dispenser.

FIG. 4 shows an exemplary module for expected infestation map determination.

FIG. 5 illustrates an exemplary infestation map for the agricultural field.

FIG. 6 shows an exemplary list of semiochemicals “A”, “B”, and “C” found in the semiochemical product database.

FIG. 7 shows a mobile treatment equipment configured to implement the application scheme.

FIG. 8 illustrates a flow chart of a method for implementing the application scheme.

### DETAILED DESCRIPTION OF EMBODIMENT

In the following, the approach is described in relation with the application of pheromone products for the purposes of illustration. However, anyone of ordinary skill in the art will appreciate that the method and apparatus described above and below can be adapted to other semiochemical products, such as an allomone product, a kairomone product, an attractant product, and a repellent product. Accordingly, the following described examples are set forth without any loss of generality to, and without imposing limitations upon, the claimed invention.

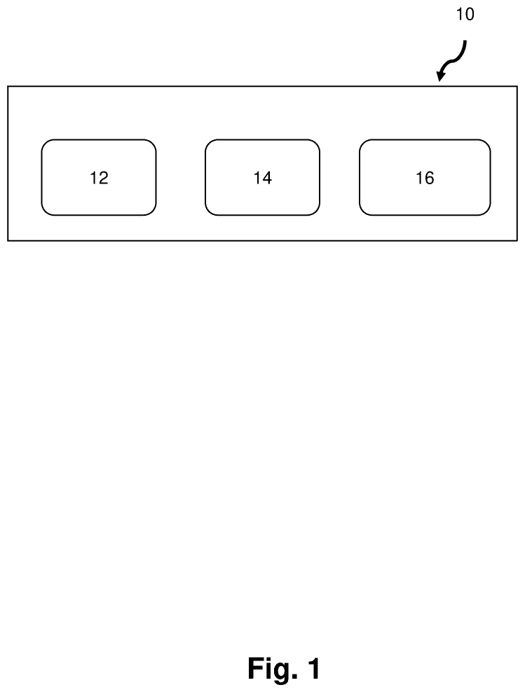

FIG. 1 illustrates a block diagram of an exemplary apparatus 10 for generating an application scheme for a semiochemical treatment for controlling a harmful organism on an agricultural field using a mobile treatment device comprising at least one dispenser. The apparatus 10 includes an input unit 12, one or more processing units 14, and an output unit 16.

In general, the apparatus 10 may comprise various physical and/or logical components for communicating and manipulating information, which may be implemented as hardware components (e.g. computing devices, processors, logic devices), executable computer program instructions (e.g. firmware, software) to be executed by various hardware components, or any combination thereof, as desired for a given set of design parameters or performance constraints. Although FIG. 1 may show a limited number of components by way of example, it can be appreciated that a greater or a fewer number of components may be employed for a given implementation.

In some implementations, the apparatus 10 may be embodied as, or in, a device or apparatus, such as a server, workstation, or mobile device. The apparatus 10 may comprise one or more microprocessors or computer processors, which execute appropriate software. The processing unit 14 of the apparatus 10 may be embodied by one or more of these processors. The software may have been downloaded and/or stored in a corresponding memory, e.g. a volatile memory such as RAM or a non-volatile memory such as flash. The software may comprise instructions configuring the one or more processors to perform the functions described herein.

It is noted that the apparatus 10 may be implemented with or without employing a processor, and also may be implemented as a combination of dedicated hardware to perform some functions and a processor (e.g. one or more programmed microprocessors and associated circuitry) to perform other functions. For example, the functional units of the apparatus 10, e.g. the input unit 12, the one or more processing units 14, and the output unit 16 may be implemented in the device or apparatus in the form of programmable logic, e.g. as a Field-Programmable Gate Array (FPGA). In general, each functional unit of the apparatus may be implemented in the form of a circuit.

In some implementations, the apparatus 10 may also be implemented in a distributed manner. For example, some or all units of the apparatus 10 may be arranged as separate modules in a distributed architecture and connected in a suitable communication network, such as a 3rd Generation Partnership Project (3GPP) network, a Long Term Evolution (LTE) network, Internet, LAN (Local Area Network), Wireless LAN (Local Area Network), WAN (Wide Area Network), and the like.

The input unit 12 and the output unit 16 may include hardware and/or software to enable the apparatus 10 to receive a data input, and to communicate with other devices and/or a network. For example, the input unit 12 may receive the data input via a wired connection or via a wireless connection. The output unit 16 may also provide cellular telephone communications, and/or other data communications for the apparatus 10.

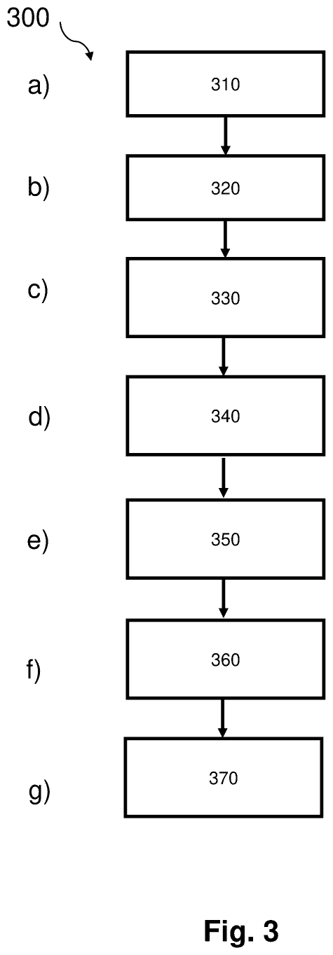

The processing unit(s) 14 may execute instructions to perform the method described herein, which will be explained in detail with respect to the embodiment shown in FIG. 3.

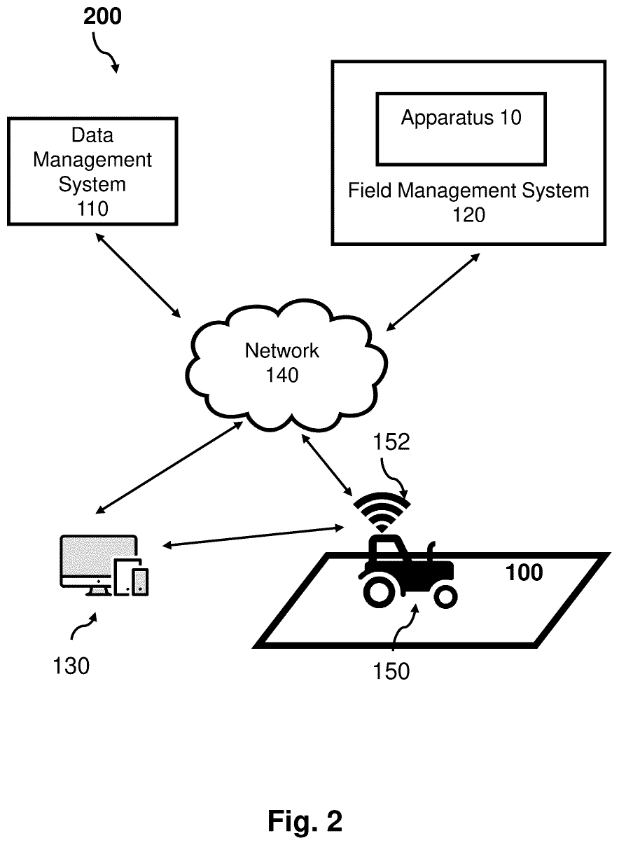

FIG. 2 illustrates an exemplary harmful organism management system 200, in which the apparatus 10 may be implemented. The exemplary harmful organism management system 200 may comprise a data management system 110, a field management system 120, an electronic communication device 130, a network 140, and a mobile treatment device 150. In this example, the apparatus 10 is embodied as, or in, the field management system 120, e.g., residing in the field management system 120 as a software.

The data management system 110 of the illustrated example may store databases, applications, local files, or any combination thereof. The data management system 110 may comprise data obtained from one or more data sources. In some examples, the data management system 110 may include data obtained from a user device, which may be a computer, a smartphone, a tablet, a smartwatch, a monitor, a data storage device, or any other device, by which a user, including humans and robots, can input or transfer data to the data management system 110. In some examples, the data management system 110 may comprise data obtained from one or more sensors. The term “sensor” is understood to be any kind of physical or virtual device, module or machine capable of detecting or receiving real-world information and sending this real-world information to another system, which may include temperature sensor, humidity sensor, moisture sensor, pH sensor, pressure sensor, soil sensor, crop sensor, water sensor, cameras, or any combination thereof. In some examples, the data management system 110 may store one or more databases, which may be any organized collection of data, which can be stored and accessed electronically from a computer system, and from which data can be inputted or transferred to the data management system 110.

In some examples, the data management system 110 may comprise information about one or more agricultural fields. For example, the data management system 110 may comprise field data of different agricultural fields. The field data may include georeferenced data of different agricultural areas and the associated treatment map(s). The field data may comprise information about one or more of the following information: crop present on the field (e.g. indicated with crop ID), the crop rotation, the location of the field, previous treatments on the field, sowing time, etc.

In some examples, the data management system 110 may comprise semiochemical product data, which may comprise information about a plurality of semiochemical products, such as pheromones, allomones, kairomones, attractants, and repellents. For example, the information may include semiochemical specifiers (e.g., semiochemical IDs), and targeted harmful organism specifiers (e.g., harmful organism IDs). In some examples, the data management system 110 may comprise a semiochemical product database, which may cover all or most of the common semiochemicals. In some examples, the semiochemical product database may be limited semiochemicals of a certain provider. Moreover, it is also possible to limit the semiochemical product database to semiochemicals allowed in a respective jurisdiction. The semiochemical product database might be provided by a third party. However, it is also possible that a user creates a tailored semiochemical product database by scanning the labels of each semiochemical product he/she intends to use and by acquiring the respective information about each semiochemical product from supplier databases. By means of the latter, it is also possible that a user supplements a semiochemical product database adding information about further semiochemical products.

The field management system 120 of the illustrated example may be a server that provides a web service to facilitate management of data. The field management system 120 may comprise a data extraction module (not shown) configured to identify data in the data management system 110 that is to be extracted, retrieve the data from the data management system 110, and provide the retrieved data to the apparatus 10, which processes the extracted data according to the method as described herein. The processed data and the final outputs of the apparatus 10 may be provided to a user output device (e.g., the electronic communication device 130), in an output database (e.g., in the data management system 110), and/or as a control file (e.g., for controlling the mobile treatment device 150). The term “user output device” is understood to be a computer, a smartphone, a tablet, a smartwatch, a monitor, a data storage device, or any other device, by which a user, including humans and robots, can receive data from the field management system, such as the electronic communication device 130. The term “output database” is understood to be any organized collection of data, which can be stored and accessed electronically from a computer system, and which can receive data, which is outputted or transferred from the field management system 120. For example, the output database may be provided to the data management system 110. The term “control file”, also referred to as configuration filed, is understood to be any binary file, data, signal, identifier, code, image, or any other machine-readable or machine-detectable element useful for controlling a machine or device, for example the mobile treatment device 150. In some examples, the apparatus 10 may provide an application scheme, which may be provided to the electronic communication device 130 to allow the farmer to configure the mobile treatment device 150 according to the application scheme. In some examples, the apparatus 10 may provide a configuration profile, which may be loaded to the mobile treatment device 150 to configure the mobile treatment device 150 to release the semiochemicals according to the determined application timing.

The electronic communication device 130 of the illustrated example may be a desktop, a notebook, a laptop, a mobile phone, a smart phone and/or a PDA. The electronic communication device 130 may comprises a data analysis application, which may be a software application that enables a user to manipulate data extracted from the data management system 110 by the field management system 120 and to select and specify actions to be performed on the individual data. For example, the data analysis application may be a desktop application, a mobile application, or a web-based application. The data analysis application may comprise a user interface, such as an interactive interface including, but not limited to, a GUI, a character user interface, and a touch screen interface. Via the software application, the user may access the field management system 120 using e.g., Username and Password Authentication to obtain an application scheme and/or configuration file usable for configuring the mobile treatment device 150. The application scheme and/or the configuration file may comprise a dose rate map e.g., with one or more semiochemical product IDs.

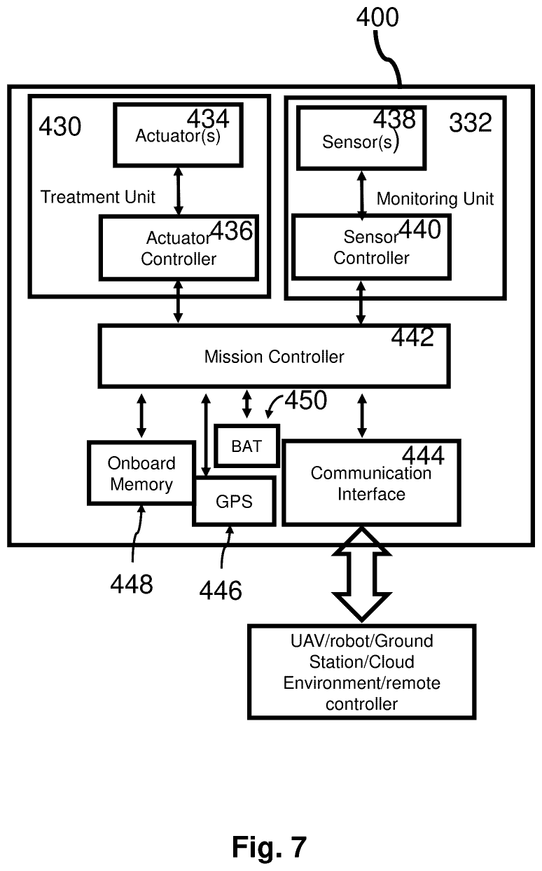

The mobile treatment device 150 of the illustrated example may be e.g. ground robots with one or more dispensers, aerial dispensers, or other dispensers for releasing the semiochemicals to the agricultural area 100. In the example of FIG. 2, the mobile treatment device 150 may be smart farming machinery. The smart farming machinery may include a connectivity system 152. The connectivity system 152 may be configured to communicatively couple the smart farming machinery 150 to the computing environment. For example, the smart machinery may receive the configuration file from the field management system 120 or from the electronic communication device 130, and release the semiochemicals according to the dose rate map specified in the configuration file. An exemplary dispenser 400 will be described hereinafter and in particular with respect to the example illustrated in FIG. 7

The network 140 of the illustrated example communicatively couples the data management system 110, the field management system 120, the electronic communication device 130, and the mobile treatment device 150. In some examples, the network 140 may be the internet. Alternatively, the network 140 may be any other type and number of networks. For example, the network 140 may be implemented by several local area networks connected to a wide area network. For example, the data management system 110 may be associated with a first local area network, the field management system 120 may be associated with a second local area network, and the electronic communication device 130 may be associated with a third local area network. The first, second, and third local area networks may be connected to a wide area network. Of course, any other configuration and topology may be utilized to implement the network 140, including any combination of wired network, wireless networks, wide area networks, local area networks, etc.

FIG. 3 shows a flow chart of a computer-implemented method 300 for generating an application scheme for a semiochemical treatment for controlling a harmful organism on an agricultural field using a mobile treatment device comprising at least one dispenser. In the following, an exemplary order of the steps according to the present disclosure is explained. However, the provided order is not mandatory, i.e. all or several steps may be performed in a different order or simultaneously.

The method 300 may be carried out by an apparatus, such apparatus 10 shown in FIG. 1 or FIG. 2. The apparatus may be a computing device or a computing system, regardless of the platform, being suitable for executing program code related to the proposed method. As a further example, the apparatus may be embodied as, or in, a computer system. The apparatus may be embodied as, or in, a remote server that provides a web service to facilitate harmful organism management of a field e.g. by a farmer of the agricultural field. The remote server may have a more powerful computing power to provide the service to multiple users to manage many different agricultural fields. The remote server may include an interface through which a user can authenticate (e.g. by providing a username and password); and an interface for creating, modifying, and deleting configuration information of the mobile treatment devices of the user. For example, the configuration information may comprise geographical information of the target area, an application scheme for harmful organism treatment, etc. The configuration information may be loaded onto the mobile treatment devices to enable the mobile treatment devices to perform harmful organism treatment.

Beginning at block 310, i.e., step a), information about an expected presence of the harmful organism is provided for an upcoming period. The upcoming period may be a time window, within which the user plans to treat the harmful organism of the agricultural field. The upcoming period may be e.g., the upcoming days, week, month, or season. The information about an expected presence of the harmful organism may comprise one or more of the following information: distribution of the harmful organism by locality, level of infestation (e.g., 0%-100%), sources of infestation (e.g., pest species), and life stages (i.e. eggs, larvae, pupae, and adults) for the upcoming period.

In some examples, the information about the expected presence of the harmful organism may be provided by a user e.g., via the electronic communication device 150 shown in FIG. 2.

In some examples, the information about the expected presence of the harmful organism may be determined e.g., by the field management system 120 shown in FIG. 2. For example, the field management system 120 may comprise a module for expected infestation map determination.

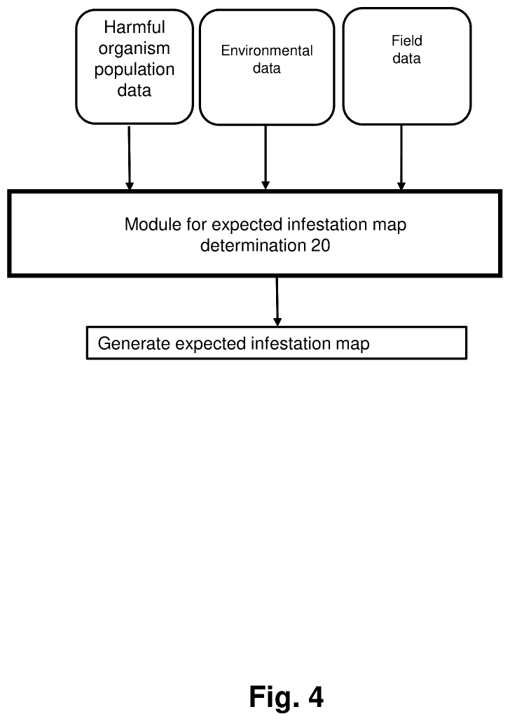

FIG. 4 shows an exemplary module 20 for expected infestation map determination. The module 20 may be embodied in the field management system 120 or in the apparatus 10.

In some examples, as shown in FIG. 4, the module 20 may receive harmful organism population data. The harmful organism population data may include information about historic presence of the harmful organism, which may be retrieved from e.g., the data management system 110 shown in FIG. 2. The information about historic presence of the harmful organism may be provided by an infestation map indicating details of the distribution of the harmful organism by locality in the past days, weeks, months, seasons, and/or years. Season and sources of infestation may also be provided in the infestation map. Alternatively or additionally, the harmful organism population data 40 may comprise information about current presence of the harmful organism. This may be provided by a user by means of a user interface e.g. using the electronic communication device 130 shown in FIG. 2 or by means of image recognition of an image captured by a camera inside pheromone traps. The harmful organism(s) may be provided with harmful organism specifiers. The harmful organism specifiers may be provided by a common or scientific name of a harmful organism or also by any other identifier, e.g. an identification number (ID) or the like.

In some examples, as shown in FIG. 4, environmental data for the field region may be provided to the module 20. Environmental data, like weather conditions, may have an influence on the development of certain harmful organisms. For example, hot and dry weather may favour the weevil development. The adult weevil can survive up to 94 days. The weather data can be provided by a third party, e.g. a service provider, or by on-site sensors. Moreover, depending on the remaining time until the application timing, it is possible to add the weather data at a later point in time and/or to include/update the weather data at a predetermined time interval before the application timing. Other data about the crop environment may also be obtained e.g. from on-site sensors like moisture sensor, pH sensor, pressure sensor, soil sensor, water sensor, cameras, or any combination thereof.

In some examples, field data of the agricultural field may be provided to the module 20. For example, the field data may comprise crop rotation information. Rotating crops may help to reduce pest build-up, especially of those in the soil, such as root-feeding insects and fungi.

Therefore, modelling, for example, based on the harmful organism population data with the addition of e.g., environmental data and field data, can indicate an expected harmful organism population for the upcoming period (e.g., days, week, month, or season). The expected presence of the harmful organism may be provided by an infestation map which may comprise one or more of the following information: distribution of the harmful organism by locality, level of infestation (e.g., 0%-100%), sources of infestation (e.g., pest species), and life stages (i.e. eggs, larvae, pupae, and adults) for the upcoming period.

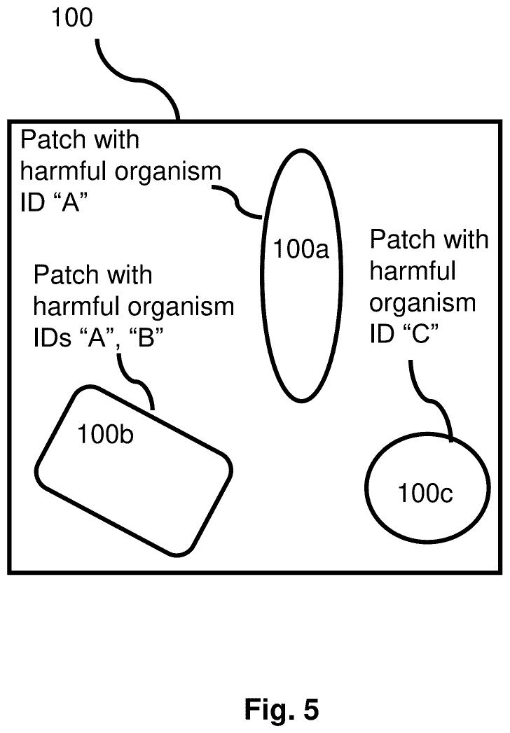

FIG. 5 illustrates an exemplary expected infestation map for the agricultural field 100. In the example of FIG. 5, the expected infestation map shows distribution of the harmful organism by locality and sources of infestation. In particular, the expected infestation map comprises three types of harmful organisms with IDs “A”, “B” and “C”. In particular, the patch 100a of the field is associated with harmful organism ID “A”. In other words, there is a likelihood of presence of harmful organism “A” in the patch 100a for the upcoming period. The patch 100b of the field is associated with harmful organism IDs “A” and “B”. The patch 100c of the field is associated with harmful organism ID “C”. The expected infestation map may further comprise information about a level of infestation (not shown), which may be useful for determining an amount of semiochemical product(s) to be applied. In some examples, the expected infestation map may further comprise information about life stages (i.e. eggs, larvae, pupae, and adults) for the upcoming period. The above information may be useful to indicate the need to intervene before the harmful organism(s) reaches a threshold, e.g., a point at which the pest population level causes losses greater than the cost of controlling the pest.

Turning back to FIG. 3, at block 320, i.e., step b), based on the expected presence of the harmful organism, a planned application timing of applying the semiochemical treatment for treating the harmful organism on the agricultural field is provided. The planned application timing may be provided as a date or a time window, i.e., the date or the time window when a user plans to release the semiochemical(s) in a certain field. In some examples, several application timings may be provided. For example, if two or more harmful organisms are present in the field, the application timings for treating these harmful organisms may be different.

In some examples, the planned application timing may be provided by a user e.g., via the electronic communication device 130 of FIG. 2.

In some examples, the planned application timing may be determined by the field management system 120 of FIG. 2. For example, a threshold may be established for the control of the harmful organism. The application timing may be set to be a time point when the expected presence of the harmful organism exceeds the threshold specifically established for the control of the harmful organism. The expected presence of the harmful organism may be obtained e.g., from the infestation map of the illustrated example in FIG. 5. If it is determined that a plurality of harmful organisms is present or expected in the field, two or more thresholds may be established for the control of different harmful organisms. Two or more application timings may be determined accordingly for the control of different harmful organisms. The threshold(s) may be set by a user e.g., via the electronic communication device 150 of the illustrated example of FIG. 2. In some examples, it may be possible to develop local databases to assist in making decisions on the threshold(s) on an area-wide basis.

At block 330, i.e., step c), product data relating to a semiochemical product capable of targeting the harmful organism is provided to the apparatus 10. Semiochemicals, like pheromones, are usually species-specific, thus preventing adverse effects to non-targeted species. Therefore, the product data may comprise semiochemical product IDs and an indicator of targeted species (e.g., harmful organism IDs).

In some examples, the product data may be provided by a user, e.g., via the electronic communication device 150 of FIG. 2.

In some examples, the product data may be determined by performing a database search in a semiochemical product database, which may be stored in e.g., the data management system 110 shown in FIG. 2. If it is determined that a plurality of harmful organisms is present or expected in the field, it is preferred to determine, for each harmful organism, a respective semiochemical product capable of targeting the respective harmful organism.

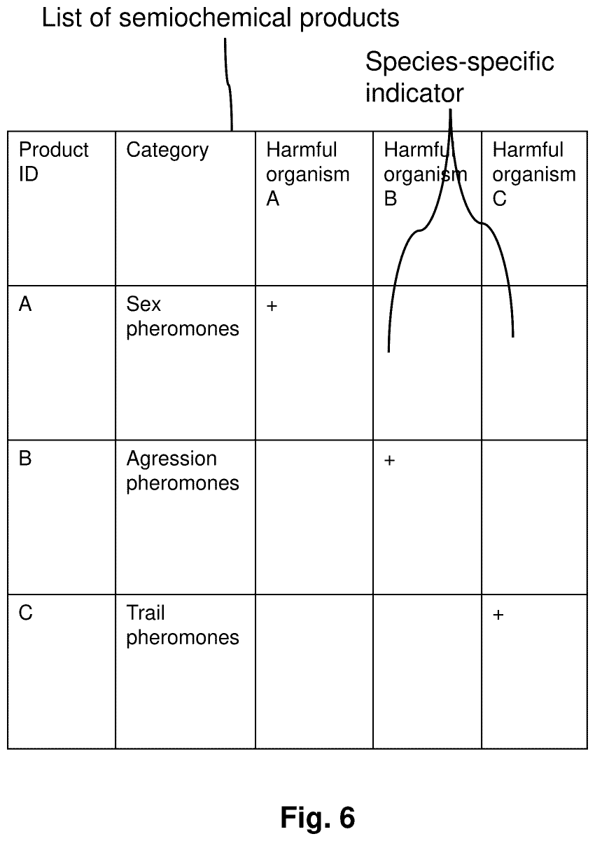

FIG. 6 shows an exemplary list of semiochemicals “A”, “B”, and “C” found in the semiochemical product database capable of targeting the extracted harmful organism IDs “A”, “B”, and “C” shown in FIG. 5, respectively. Each semiochemical product may be associated with a category indicative of the basis of the type of interaction they mediate. In the example of FIG. 6, the semiochemical product “A” is associated with the category “sex pheromones”, which indicates that the semiochemical product “A” belongs to chemicals that primarily affect an interaction between the sexes (e.g. sex pheromone in moths that attract males to females). The semiochemical product “B” is associated with the category “aggression pheromones”, which indicates that the semiochemical product “B” belongs to chemicals that cause an increase in the density of the animals (usually both sexes) in the vicinity of the pheromone source. The semiochemical product “C” is associated with the category “trail pheromones”, which indicates that the semiochemical product “C” belongs to chemicals secreted by workers of social insects to recruit other individuals to food source or to a new colony site.

Each semiochemical product may have a species-specific indicator useful for indicating the targeted harmful organism. In the example shown in FIG. 6, the semiochemical product “A” is capable of targeting the harmful organism “A”. The semiochemical product “B” is capable of targeting the harmful organism “B. The semiochemical product “C” is capable of targeting the harmful organism “C”.

The product data of the semiochemical products “A”, “B”, and “C” may then be provided to the apparatus 10.

Turning back to FIG. 3, at block 340, i.e. step d), at least one of field data or environmental data at the planned application timing is provided. The field data is indicative of a field condition at the planned application timing and/or the environmental data is indicative of an environmental condition at the planned application timing.

At block 350, i.e. step e), based on the product data and the at least one of field data or environmental data at the planned application timing, a minimum concentration of the semiochemical product for affecting a behaviour of the harmful organism is determined.

The minimum concentration of the semiochemical product is an amount of the semiochemical product per volume (e.g., in nanograms per m³) that is sufficient to affect desired results. For example, a minimum concentration of the semiochemical product may refer to an amount of the pheromone composition per volume that is sufficient to disrupt mating of a particular insect population of interest in a given locality. If it is determined that a plurality of harmful organisms is present or expected in the field, it is preferred to determine, for each harmful organism, a respective minimum concentration of the semiochemical product for affecting a behaviour of the respective harmful organism.

The minimum concentration of the selected semiochemical product is adjusted to account for a loss or dissipation of the selected semiochemical product caused by the field condition and/or the environmental condition. Exemplary environmental conditions may include, but are not limited to, wind effects, temperature and humidity (which may cause evaporation in the sky), and absorption by soil. Exemplary field conditions may include, but are not limited to field orography, particular and specific field conditions (presence of roads, flow of water, etc.), and field edges. The losses may be estimated based on historic collected data. Based on the estimated losses, the minimum concentration may be adjusted to account for the losses.

It may be preferred that the semiochemical product remains nearly constant throughout the period of the treatment as long as external wind speeds and air temperatures remain the same. Therefore, in order to ensure the constant presence of the minimum concentration of the semiochemical product throughout the period of the treatment, real-time tracking data indicative of a real-time change of the cloud of the selected semiochemical product formed in the atmosphere may be provided. The real-time tracking data is acquired by a physical sensor or estimated via a cloud simulation. Based on the real-time tracking data, the planned application timing of applying the semiochemical product may be adjusted. For example, if it is determined that the loss of the semiochemical product (e.g., due to increased wind speeds and air temperature) is higher than the estimation, the next application timing may be adjusted.

At block 360, i.e., step f), based on the minimum concentration of the semiochemical product, a dose rate of the selected semiochemical product to be spread by the at least one dispenser into an atmospheric vapour forming a cloud which envelops crops on the agricultural field is determined by the apparatus 10. The dose rate is understood as amount of product to be applied per area, for example expressed as liter per hectare (L/ha).

If it is determined that a plurality of harmful organisms is present or expected in the field, it is preferred to determine, for each harmful organism, a respective dose rate based on the expected harmful organism population in different areas of the field.

At block 370, i.e., step g), the application scheme is generated by the apparatus 10 based on the determined dose rate, e.g., in the form of a dose rate map with semiochemical product ID(s).

In general, the dispenser(s) of the mobile treatment device should be displaced to release the semiochemical product(s) as uniformly as possible with the exception of areas featuring particular topographic conditions or characterized by the presence of tall crops. In order to enable the generation of a homogeneous cloud of semiochemical product for the areas characterized by the presence of tall crops, it may be beneficial to have height-adjustable dispenser(s), which may be adjusted to release the semiochemical product at a desired vertical position, e.g., positioning the dispenser(s) in the upper third of the crop. In order to ensure the a homogeneous cloud coverage of areas featuring particular orthographic conditions, the dispenser(s) may be moved and positioned non-uniformly to release the semiochemical product. For example, the dispenser(s) may need to be applied irregularly with more release of semiochemical product in the upper part of the slope and fewer release of the semiochemical product in the lower part of the valley, thus leaving the overall dosage unchanged. Therefore, in some examples, crop data may be provided relating to a crop grown or to be grown and an expected crop height and/or an expected crop density at the at least one planed application timing. Alternatively or additionally, field data may be provided indicative of a field topographic condition. Positioning of the at least one dispenser for spreading the selected semiochemical product is determined based at least on the crop data and/or the field topographic condition. The positioning information may also be provided to the application scheme.

In some examples, the generated application scheme may be provided as a recommendation by means of a user interface (e.g. a display) e.g., in the electronic communication device 130 shown in FIG. 2. The recommendation may comprise a filling guidance including the required semiochemical products and their ratios to be filled into one or more tanks of a dispenser or any other mixing unit.

In some examples, control data may be generated based on the generated application scheme for controlling a mobile treatment equipment. The control data may include a semiochemical product ID and a dose rate map. If two or more semiochemical products will be used, the control data may include a plurality of semiochemical product IDs and product ratio per product ID. The product ratio per product ID may be determined from the expected infestation map. In some examples, the dose rate may be determined for the mix in a single tank system. In some examples, the dose rate may be determined on a per-product ID basis for products in multi-tank system. The control data may be provided to a mobile treatment device configured to implement the application scheme.

FIG. 7 shows a mobile treatment device 400 configured to implement the application scheme. The mobile treatment device 400 may comprise a treatment unit 430, a monitoring unit 432, a mission controller 442, a communication interface 444, a GPS 446, an on-board memory 448, and a battery (BAT) 450. The mobile treatment device 400 may be releasably attached or directly mounted to a ground platform (e.g. tractor) or an aerial platform (e.g. drone).

The treatment unit 430 may comprise an actuator(s) 434 and an actuator controller 436. The actuator(s) 434 is configured to regulate semiochemical release from one or more dispensers in response to a control signal provided by the actuator controller 436. For example, the one or more dispensers may comprise a puffer, which comprise an electronically controlled mechanical device (cabinet), and an aerosol pheromone formulation (canister). The cabinet is used to dispense the pheromone in the canister.

The monitoring unit 432 may comprise a sensor(s) 438 and a sensor controller 440 for controlling the sensor to sense one or more conditions on the field. The sensor(s) 438 may be an optical sensor providing an image of the field. Suitable optical sensors are multispectral cameras, stereo cameras, IR cameras, CCD cameras, hyperspectral cameras, ultrasonic or LIDAR (light detection and ranging system) cameras, or any combination thereof. Alternatively, or additionally, the sensor(s) may include further sensors to measure humidity, light, temperature, wind or any other suitable condition on the field.

The treatment unit 430 and the monitoring unit 432 are communicatively coupled to the mission controller 442 in a wired or wireless connection. The mission controller 442 is configured to control the treatment unit 430 and the monitoring unit 432 based on the application scheme generated according to the method disclosed therein.

The communication interface 444 may include hardware and/or software to enable the mobile treatment device 400 to communicate with other devices and/or a network, via a wired or wireless connection. For example, the communication interface 444 may enable the mobile treatment device 400 to communicate with an unmanned aerial vehicle (UAV), a robot, a ground station, a cloud environment, a remote controller, yield maps, or any combination thereof.

The on-board memory 448 may be a volatile memory such as RAM or a non-volatile memory such as flash. The software comprising instructions configuring the treatment unit and the monitoring unit to perform the functions according to the application scheme can be downloaded and stored in the on-board memory 448.

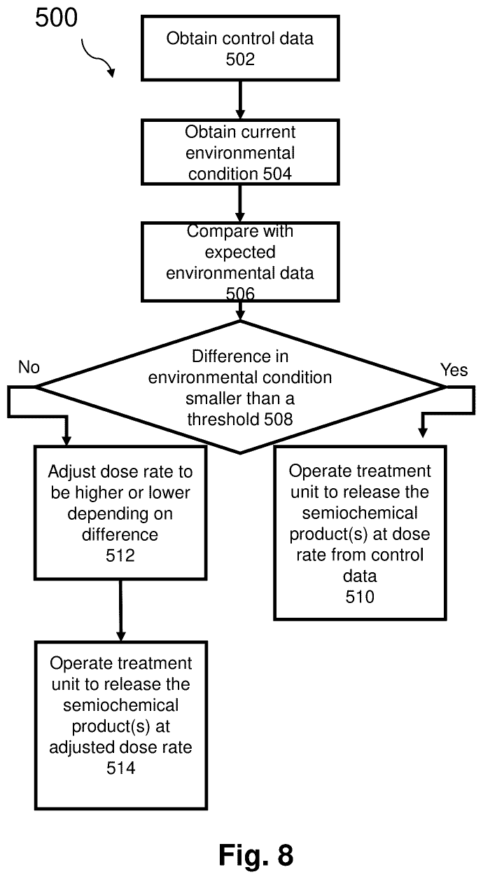

FIG. 8 illustrates a flow chart of a method 500 for implementing the application scheme.

In step 502, a mobile treatment equipment, such as mobile treatment equipment 400, obtains control data. The control data comprises application scheme provided by the apparatus 10 shown in FIGS. 1 and 2. The application scheme may comprise a dose rate map with semiochemical product ID(s). In some examples, the application scheme may comprise positioning information for releasing the semiochemical product.

In step 504, the mobile treatment equipment obtains current environmental condition data. For example, in the example shown in FIG. 7, the sensor controller 440 may control the sensor to sense one or more current environmental conditions on the field. The sensor(s) may include further sensors to measure humidity, light, temperature, wind or any other suitable environmental condition on the field.

In step 506, the current environmental condition is compared with the expected environmental condition data, which may be obtained from a weather forecasting service. If the difference is smaller than a threshold, the agricultural equipment operates the treatment unit to release the semiochemical product(s) at the dose rate from the control data in step 510. If the difference is equal to or greater than the threshold, the agricultural equipment adjusts the dose rate to be higher or lower depending on the difference in step 512, and operates the treatment unit to release the semiochemical product(s) in step 514.

This exemplary embodiment of the invention covers both, a computer program that right from the beginning uses the invention and a computer program that by means of an up-date turns an existing program into a program that uses the invention.

Further on, the computer program element might be able to provide all necessary steps to fulfil the procedure of an exemplary embodiment of the method as described above. According to a further exemplary embodiment of the present invention, a computer readable medium, such as a CD-ROM, is presented wherein the computer readable medium has a computer program element stored on it which computer program element is described by the preceding section.

A computer program may be stored and/or distributed on a suitable medium, such as an optical storage medium or a solid state medium supplied together with or as part of other hardware, but may also be distributed in other forms, such as via the internet or other wired or wireless telecommunication systems.

However, the computer program may also be presented over a network like the World Wide Web and can be downloaded into the working memory of a data processor from such a network. According to a further exemplary embodiment of the present invention, a medium for making a computer program element available for downloading is provided, which computer program element is arranged to perform a method according to one of the previously described embodiments of the invention.

1. A computer-implemented method for generating an application scheme for a semiochemical treatment for controlling a harmful organism on an agricultural field using a mobile treatment device comprising at least one dispenser, the method comprising:
a) providing information about an expected presence of the harmful organism for an upcoming period;
b) providing, based on the expected presence of the harmful organism, a planned application timing of applying the semiochemical treatment for treating the harmful organism on the agricultural field;
c) providing product data relating to a semiochemical product capable of targeting the harmful organism;
d) providing, at least one of field data or environmental data at the planned application timing, wherein the field data is indicative of a field condition at the planned application timing and/or the environmental data is indicative of an environmental condition at the planned application timing;
e) determining, based on the product data and the at least one of field data or the environmental data at the planned application timing, a minimum concentration of the semiochemical product for affecting a behaviour of the harmful organism;
f) determining, based on the minimum concentration of the semiochemical product, a dose rate of the selected semiochemical product to be spread by the at least one dispenser into an atmospheric vapour forming a cloud which envelops crops on the agricultural field; and
g) generating the application scheme based on the determined dose rate.

2. The computer-implemented method according to claim 1,
wherein crop data is provided relating to a crop grown or to be grown and an expected crop height and/or an expected crop density at the at least one planed application timing, and/or field data is provided that is indicative of a field topographic condition; and
wherein positioning of the at least one dispenser for spreading the selected semiochemical product is determined based at least on the crop data and/or the field topographic condition.

3. The computer-implemented method according to claim 1, further comprising:
providing real-time tracking data indicative of a real-time change of the cloud of the selected semiochemical product formed in the atmosphere; and
adjusting, based on the real-time tracking data, the planned application timing of applying the selected semiochemical product.

4. The computer-implemented method according to claim 3,
wherein the real-time tracking data is acquired by a physical sensor or estimated via a cloud simulation.

5. The computer-implemented method according to claim 1, further comprising:
generating a control file comprising control parameters to control the mobile treatment device for a semiochemical treatment for treating the harmful organism in accordance with the application scheme.

6. The computer-implemented method according to claim 1, further comprising:
providing the generated application scheme via a user interface to guide a user to control the mobile treatment device for a semiochemical treatment for treating the harmful organism.

7. The computer-implemented method according to claim 1,
wherein the semiochemical product comprises one or more of a pheromone product, an allomone product, a kairomone product, an attractant product, and a repellent product.

8. An apparatus for generating an application scheme for a semiochemical treatment for controlling a harmful organism on an agricultural field using a mobile treatment device comprising at least one dispenser, the apparatus comprising one or more processing units to generate the application scheme, wherein the one or more processing units receive instructions, which when executed on the one or more processing units, perform the method steps of claim 1.

9. A harmful organism management system, comprising:
an apparatus configured to generate an application scheme for a semiochemical treatment for controlling a harmful organism on an agricultural field according to claim 8; and
a mobile treatment device comprising at least one dispenser configured to implement the application scheme.

10. The harmful organism management system according to claim 9, wherein the mobile treatment device is configured to implement the application scheme when a presence of the harmful organism exceeds the thresholds specifically established for the control of the harmful organism.

11. A computer program element comprising instructions to cause an apparatus to execute the steps of method of claim 1, wherein the apparatus is an apparatus for generating an application scheme for a semiochemical treatment for controlling a harmful organism on an agricultural field using a mobile treatment device comprising at least one dispenser, the apparatus comprising one or more processing units to generate the application scheme, wherein the one or more processing units receive instructions, which when executed on the one or more processing units, perform the method steps of claim 1.

12. A computer readable medium having stored the program element of claim 11.

13. A method for controlling a harmful organism on an agricultural field comprising using a mobile treatment device comprising at least one dispenser configured to implement the application scheme generated according to claim 1.
